(19) United States
(12) Patent Application Publication
(10) Pub. No.: US 2026/0244705 A1
(43) Pub. Date: Aug. 20, 2026

(54) BLOCK SCALE REGISTER FOR MATRIX OPERATIONS

(71) Applicant: ADVANCED MICRO DEVICES, INC., Santa Clara, CA (US)

(72) Inventors: Michael Estlick, Fort Collins, CO (US); Glendon Leo Akins III, Fort Collins, CO (US)

(21) Appl. No.: 19/434,275

(22) Filed: Dec. 29, 2025

Related U.S. Application Data
(60) Provisional application No. 63/758,722, filed on Feb. 14, 2025.

(51) Int. Cl. G06F 17/16

(52) U.S. Cl. CPC G06F 17/16

(57) ABSTRACT

A processor includes a scalable matrix arithmetic unit with multiple block scale registers to provide scale data to different groups of arithmetic elements. The matrix arithmetic unit employs the arithmetic elements to perform matrix operations, such as outer product operations, using provided arithmetic operands. The arithmetic elements are configured to apply the scale data to the operands prior to or during the matrix operations. By employing block scale registers to provide the scale data to the groups of arithmetic elements, the processor is able to efficiently implement scale operations without consuming an undesirably large amount of circuit area.

### BACKGROUND

Processing systems are sometimes used to execute machine learning, artificial intelligence (AI), and similar applications. For example, some processing systems implement one or more machine learning models (MLMs). To implement such a model, the processing system executes a set of mathematical operations corresponding to the MLM. For example, to implement an MLM, a processing system sometimes executes a set of matrix multiplication operations in order to multiply an activation matrix, representing a set of activations for a layer of the MLM, with a weight matrix, representing weights associated with the MLM layer. In order to increase efficiency, some processing systems employ specially designed and configured arithmetic circuitry to execute these mathematical operations, such as a dedicated matrix multiplication unit. However, existing approaches to this dedicated circuitry are relatively inflexible and inefficient.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including matrix arithmetic circuitry including groups of arithmetic elements and corresponding block scale registers in accordance with some implementations.

FIG. 2 is a block diagram illustrating an example of the matrix arithmetic circuitry of FIG. 1 with NxN groups of arithmetic elements and corresponding block scale registers in accordance with some implementations.

FIG. 3 is a block diagram illustrating an example of the matrix arithmetic circuitry of FIG. 2 with scale factors assigned to different block scale registers in accordance with some implementations.

FIG. 4 is a block diagram illustrating an example of the matrix arithmetic circuitry of FIG. 1 with NxM groups of arithmetic elements and corresponding block scale registers in accordance with some implementations.

FIG. 5 a block diagram illustrating an example of the block scale registers of FIG. 3 being multiplexed to provide data to arithmetic elements in accordance with some implementations.

FIG. 6 is a block diagram illustrating an example of a block scale register of the matrix arithmetic circuitry including a physical register file in accordance with some implementations.

FIG. 7 is a flow diagram illustrating a method of employing a block scale register with a physical register file to provide scale data to an arithmetic element of a processor in accordance with some implementations.

FIG. 8 illustrates different configurations of a scalable matrix arithmetic unit in accordance with some implementations.

FIG. 9 illustrates a matrix engine configuration that shares arithmetic hardware between elements in accordance with some implementations.

### DETAILED DESCRIPTION

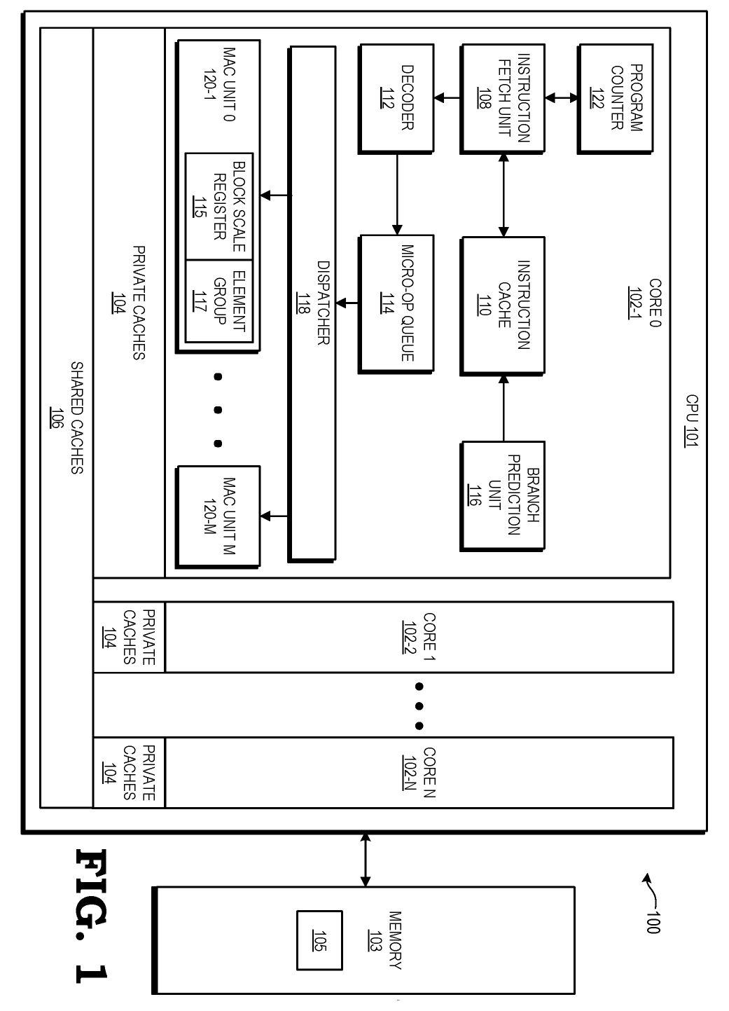

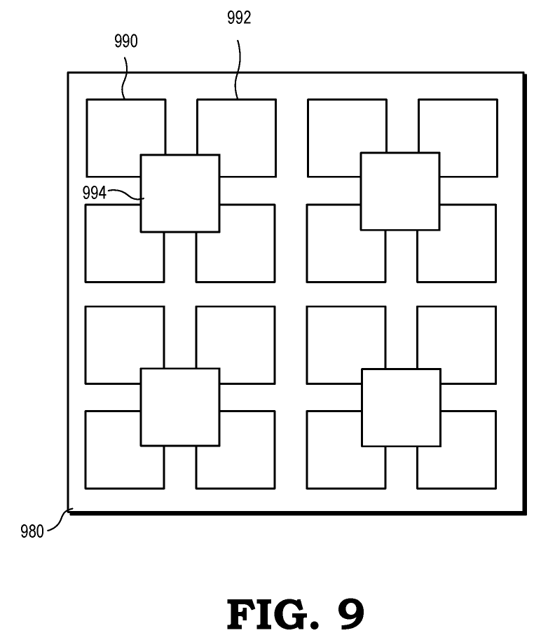

FIGS. 1-9 illustrate techniques for implementing a scalable matrix arithmetic unit with multiple block scale registers to provide scale data to different groups of arithmetic elements. The matrix arithmetic unit employs the arithmetic elements to perform matrix operations, such as outer product operations, using provided arithmetic operands. The arithmetic elements are configured to apply the scale data to the operands prior to or during the matrix operations. By employing block scale registers to provide the scale data to the groups of arithmetic elements, the processor is able to efficiently implement scale operations without consuming an undesirably large amount of circuit area.

To illustrate, in some implementations a processor is generally configured to execute programs or applications including machine learning, neural network, artificial intelligence operations, referred to generally herein as artificial intelligence operations. Such operations typically require execution of a relatively large number of matrix operations, such as outer product operations, dot product operations, matrix multiplication operations, and the like. In addition, these artificial intelligence operations sometimes demand scaling of operands in conjunction with the matrix operations. For example, some artificial intelligence operations are more efficiently implemented by quantizing one or more operands (e.g., weight or activation operands) to a specified data format in conjunction with an outer product or other matrix operation.

Accordingly, to efficiently implement scaling and matrix operations, in some implementations a processor supports special block scale data formats, such as Open Compute Product Microscaling Format (OCP MX). Furthermore, to efficiently support such block scale data formats, the processor includes a plurality of block scale registers (BSRs). As used herein, a block scale register (BSR) is a register that stores, for each block of a set of data, scale elements to be applied to the data during a matrix operation (e.g., an outer product operation). The matrix operations are implemented by circuitry, referred to as arithmetic element units, that executes the arithmetic operations (e.g., multiplication, accumulation, or a combination thereof) on corresponding elements of the matrix operands.

One way to support the block scale data formats is for a processor to include a single BSR that provides the block scale data to each arithmetic element unit of a matrix unit. However, this approach requires a relatively high number of circuit paths to route the block scale data to each element and requires at least some of the circuit paths to be of a relatively high (long) length. Another approach is to include a BSR for each arithmetic element unit of the matrix unit. However, this approach requires a relatively high number of BSRs that collectively consume a relatively large portion of the processor.

Accordingly, using the techniques described herein, a processor includes a matrix unit wherein the arithmetic units are arranged in groups, with each group including a plurality of the arithmetic element units. As used herein, an arithmetic element group is a plurality of arithmetic elements that share circuitry, such as one or more BSRs as described further herein. Arithmetic element groups are sometimes referred to herein as “element groups” for simplicity. The matrix unit further includes a set of BSRs for each arithmetic element group. That is, each arithmetic element group is assigned a different set of BSRs, and each set of BSRs provides the scale factors to the arithmetic elements in its assigned group. This reduces the complexity of the circuity routing (e.g., the routing traces) associated with connecting the BSRs to the corresponding arithmetic elements, thereby conserving power and other system resources. In addition, the overall circuit area consumed by the BSRs is reduced compared to the approach of including a set of BSRs for each arithmetic element.

In some implementations, the processor implementing the BSRs is a multithreaded processor, that concurrently executes different program threads. In particular, the different executing threads each make use of the matrix unit including the BSRs. In some implementations, the processor is an out-of-order execution processor. In still other implementations, the processor is both an out-of-order execution processor and a multithreaded processor. To reduce the overall processing overhead associated with a context switch between the executing threads, or to allow for out-of-order execution, or both, in some implementations one or more of the BSRs is implemented as a physical register file. That is at least one BSR is associated with multiple physical registers, and the processor assigns each physical register a different physical register number (PRN), with each PRN assigned to a different executing thread or to different instructions being executed out-of-order. Control circuitry of the processor sets the PRN to be used for the BSR to the PRN assigned to the thread or instruction to be executed. This allows the matrix unit to efficiently execute matrix operations for different threads or to execute a thread in an order different from a program instruction order.

FIG. 1 illustrates a processing system 100 utilizing at least one CPU 101 configured to execute instructions for one or more applications represented by instructions and other data stored in one or more system memories 103 in accordance with some implementations. The processing system 100 is generally configured to execute the applications (e.g., computer programs) to carry out operations on behalf of an electronic device. Accordingly, in different implementations, the processing system 100 is part of one of a number of electronic devices, such as a desktop computer, laptop computer, server, smartphone, game console, tablet, and the like.

To execute these applications, the CPU 101 includes an architecture having one or more processor cores 102 each associated with one or more private caches 104 and one or more shared caches 106. These private caches 104 each include a volatile memory, non-volatile memory, or both included in or otherwise connected (e.g., by a data fabric or bus) to a processor core 102 and are each only accessible by a corresponding processor core 102. As an example, CPU 101 includes a respective first private cache (e.g., L0 cache), and a respective second private cache 104 (e.g., L1 cache) that are included in or otherwise connected to a corresponding processor core 102 such that they are each only accessible by the corresponding processor core 102. Additionally, the shared caches 106 each include a volatile memory, non-volatile memory, or both and are each connected (e.g., by a data fabric or bus) to and accessible by two or more processor cores 102. For example, CPU 101 includes a last-level cache (e.g., L3 cache) connected to and accessible by two or more processor cores (e.g., core 0102-1, core 1102-2, core N 102-N). Each of the private caches 104 and shared caches 106 are configured to store instructions to be executed by CPU 101, data (e.g., operands, values) used in the execution of the instructions, data resulting from the execution of one or more instructions, or any combination thereof. According to some implementations, for each processor core 102, the private caches 104, shared caches 106, and a system memory (e.g., random access memory (RAM)) accessible by the processor core 102 are arranged in a hierarchy based on the respective sizes of the caches and system memory.

CPU 101 is configured to execute instructions (e.g., instructions 105 stored in system memory 103) of one or more threads based on the type of architecture (e.g., an instruction set architecture (ISA)) associated with CPU 101. For example, based on CPU 101 having a complex instruction set computer (CISC) instruction set architecture (e.g., x86 architecture), CPU 101 is configured to execute instructions from a CISC instruction set (e.g., x86 instruction set). Additionally, based on CPU 101 having a reduced instruction set compute (RISC) instruction set architecture (e.g., ARM instruction set architecture, AVR instruction set architecture), CPU 101 is configured to execute instructions from a RISC instruction set (e.g., ARM instruction set, AVR instruction set). To execute instructions from an instruction set for one or more threads, CPU 101 includes one or more processor cores 104 each including a program counter 122, instruction fetch unit 108, instruction cache 110, decoder 112, micro-op queue 114, branch prediction unit 116, dispatcher 118, and one or more scalable matrix engines 120. In implementations, each processor core 102 is configured to concurrently execute instructions for two or more threads. Though the example implementation presented in FIG. 1 shows CPU 101 as including three processor cores (102-1, 102-2, 102-N) representing an N number of processor cores 102, in other implementations, CPU 101 may include any number of processor cores 102 based on design choices.

The program counter 122 of a processor core 102 includes a register configured to sequentially store data (e.g., pointers) representing the memory addresses of instructions in one or more threads to be executed for an application. As an example, the program counter 122 stores data indicating the physical or virtual addresses of one or more instructions of a thread in the order in which the instructions are to be executed. Based on the memory addresses indicated in the program counter 122, the instruction fetch unit 108 of the processor core 102 fetches instructions from the instruction cache 110 to execute. This instruction cache 110, for example, includes at least a portion of a private cache 104 accessible by the processor core 102 arranged in a hierarchy with one or more other private caches 104, shared caches 106, and the system memory also accessible by the processor core 102. According to implementations, the instruction fetch unit 108 first requests an instruction at the memory address indicated by the program counter 122 from the instruction cache 110. Based on the instruction not being in the instruction cache 110, a controller of the instruction cache 110 then requests the instruction from the cache at a next level of the hierarchy. The controllers of the caches then continue requesting the instruction in this way until the instruction is found in a cache or the instruction is requested from the system memory, at which point the instruction is provided to the instruction fetch unit 108. In some implementations, the processor core 102 is configured to prefetch one or more instructions to be performed for the thread into one or more caches, such as instruction cache 110.

After the instruction fetch unit 108 has retrieved the instruction indicated by the program counter 122, the instruction fetch unit 108 provides the instruction to decoder 112 and increments the program counter 122 so as to indicate the next instruction to be executed. As an example, after retrieving an instruction, instruction fetch unit 108 stores the instruction in an instruction register included in or otherwise connected to decoder 112. The decoder 112 includes circuitry configured to decode the instruction to determine the operation code (“op-code”) of the instruction, one or more operands associated with the instruction, or both. For example, from the instruction, the decoder 112 determines an op-code (e.g., micro op-code) indicating a type of instruction (e.g., load instruction, store instruction, ADD instruction, subtract instruction, branch instruction, conditional branch instruction, shift instruction) and which scalable matrix engine 120 is to execute the instruction. After decoding the instruction, the decoder 112 stores data indicating the op-code and operands of the instruction in a micro-op queue 114. This micro-op queue 114 includes one or more queues configured to store the decoded op-code (e.g., micro op-code) of instructions before the decoded op-code is provided to the scalable matrix engine 120 indicated by the op-code. According to some implementations, based on an instruction indicating a conditional branch instruction, branch prediction unit 116 is configured to predict one or more additional instructions. For example, from the conditional branch instruction, the branch prediction unit 116 determines a predicted branch (e.g., a branch predicted to be taken when the instruction is executed) and an unpredicted branch (e.g., a branch not predicted to be taken when the instruction is executed). Based on the predicted branch, branch prediction unit 116 then determines one or more additional instructions to be executed and, in implementations, instructs instruction fetch unit 108 to retrieve these additional instructions.

The data indicating the op-code and operands associated with the instruction is provided from the micro-op queue 114 to a dispatcher 118 that includes circuitry configured to route the data to the corresponding scalable matrix engine 120 indicated in the op-code. A scalable matrix engine 120 of the processor core 102 includes circuitry configured to execute the op-code indicated in the data provided by dispatcher 118. For example, a scalable matrix engine 120 includes a floating-point unit, integer unit, or the like. Further, each scalable matrix engine 120 includes a renamer that includes circuitry configured to allocate one or more registers of the scalable matrix engine 120 to store the operands of the instructions. For example, the renamer translates architectural registers indicated by the op-code of the instruction to one or more physical registers of the scalable matrix engine 120. After renaming the registers associated with the instruction, scheduling circuitry (e.g., scheduling queues) of the scalable matrix engine 120 provides data representing operations to be performed for the instruction to one or more execution pipes. For example, based on the operands and type of instruction, the scheduling circuitry provides data representing the operations to be performed to corresponding execution pipes. Each of these execution pipes of a scalable matrix engine 120 includes circuitry configured to perform one or more respective operations indicated by the op-code associated with an instruction such as one or more arithmetic logic unit operations, address generation unit operations, floating point add operations, fused multiply-add operations, or the like. After an execution pipe has performed an operation for an instruction, the data resulting from the performance of the operation is stored in a private cache 104, shared cache 106, system memory 103, or any combination thereof accessible by the processor core 102.

As noted above, in implementations the system 100 is configured to execute instructions configured in accordance with at least one ISA and/or ISA extension. One such ISA is the aforementioned x86 ISA. The x86 ISA is a family of instruction sets primarily used by compute systems, such as processing system 100, utilizing central processing units (CPUs) (e.g., CPU 101) or similar processors from Intel Corp. and Advanced Micro Devices (AMD) Inc. The x86 ISA primarily is directed to CISC (Complex Instruction Set Computing), which means that its instruction set includes a large number of instructions, some of which are capable of performing multiple operations in a single instruction. In an x86 architecture, a processor uses a set of general-purpose registers to perform operations on data. These registers hold operands for operations and store intermediate results. The architecture also uses a stack for function calls and local variables, with the stack pointer keeping track of the top of the stack. PUSH and POP operations are used to manipulate the stack during program execution. An Instruction Pointer holds the address of the next instruction to be executed and is automatically updated as instructions are processed. Control flow instructions modify the value of the instruction pointer, allowing for conditional and unconditional jumps in the execution flow.

The x86 ISAs include a range of basic instruction types. Data movement instructions like MOV, PUSH, and POP are used to move data between registers, memory, and the stack. Arithmetic operations such as ADD, SUB, MUL, and DIV manipulate data in registers or memory. The architecture also supports control flow instructions, such as JMP (unconditional jump) and CALL (function call), as well as conditional jump instructions like JE (jump if equal) and JNE (jump if not equal), which rely on the processor’s flags to determine whether to alter the flow of execution. Logical operations like AND, OR, XOR, and NOT are used to perform bitwise operations on data, while string operations like MOVSB (move string byte) and CMPSB (compare string byte) are designed to manipulate sequences of data. Additionally, system and interrupt instructions such as INT and IRET allow the processor to handle external events or internal errors by transferring control to interrupt service routines.

Over time, x86 processors have incorporated additional features, such as SIMD (Single Instruction, Multiple Data), which are accessed, instruction-wise, via ISA extensions to accelerate parallel computing tasks. One such set of x86 ISA extensions includes AVX (Advanced Vector Extensions), which is generally directed to improving the performance of computationally demanding applications by enabling more efficient SIMD operations. AVX enhances the x86 instruction set by offering powerful vector operations that significantly boost performance in tasks such as scientific computing, video processing, machine learning, and cryptography, where parallel data processing is crucial. One of the primary features of AVX is its wide vector registers. AVX extends the width of vector registers to 256 bits, which allows each register to hold up to eight single-precision (32-bit) floating-point numbers or four double-precision (64-bit) floating-point numbers. This increased register width enables processors to handle more data per operation, improving overall throughput and making data processing much more efficient. Moreover, AVX is designed to leverage SIMD parallelism, which means that a single instruction can perform the same operation on multiple data elements simultaneously. This parallelism is particularly beneficial for tasks like matrix multiplication or large-scale data processing, as one instruction can process multiple pieces of data at once, greatly speeding up computation. Another feature of AVX is its optimization for floating-point calculations. The instruction set supports efficient operations such as addition, multiplication, and dot products on vectorized data, which are common in applications that rely heavily on floating-point computation, including 3D rendering, scientific simulations, and signal processing. Additionally, some versions of AVX support Fused Multiply-Add (FMA) instructions, which allow a single instruction to multiply two numbers and then add the result to a third. This helps reduce the latency of calculations and improves precision, which is especially beneficial in areas like linear algebra and numerical simulations.

AVX also includes instructions that enhance performance, such as AVX-optimized arithmetic operations for floating-point vector calculations. Instructions like VADDPS and VMULPS perform vectorized addition and multiplication, respectively, while others, like VPERMILPS, allow for more complex operations like reordering elements in a vector. These instructions enable processors to handle large datasets more efficiently with fewer clock cycles.

In some implementations, the processing system 100 includes additional matrix-related features and a corresponding ISA extension to support higher compute density capabilities and to provide for operations to accelerate matrix math operations. These one or more extensions, referred to collectively herein as Advanced Computation Extension (ACE), augment AVX and scalar code with capabilities, including: ACE register state, including tile and block scale registers; data processing operations that consume AVX register input and operate on tile register state; data move operations to move data between ACE register state, AVX registers and memory; state and operations for system management. This ACE extension provides for integration between AVX vectors and ACE tile registers, combining high compute density tile processing operations with the comprehensive data processing features of AVX.

In some implementations, the processing system 100 includes, for example, a tile register file, containing a number of two-dimensional tile registers, each being, for example, 512-bits wide by 16 rows, with each row equivalent in size to a single AVX-512 vector. Each tile register row has width of 512-bits and includes a number of elements, dependent on the type of data being processed in the tile register. For example, in some implementations the processing system 100 supports 32-bit (FP32 or INT32) accumulator types and each ACE tile register row is therefore equivalent to 16 32-bit elements. In some implementations, the processing system 100 provides a number of tile registers wherein the number implemented is architecture specific.

In some implementations, each of the matrix engines 120 is configured to perform one or more matrix operations based on operations received from the dispatcher 118. For purposes of description, the matrix engines 120 will be described with respect to performing outer product operations, but it will be appreciated that in some implementations the matrix engines 120 are configured to perform additional operations, such as dot product operations.

Based on operations received from the dispatcher 118, the matrix engines 120 are configured to perform outer product operations to compute small dimension matrix multiplication results. In some implementations, each outer product operation consumes two vectors (e.g., AVX vectors) as input operands and accumulates the intermediate result with the contents of the destination tile register. The input vectors are divided into elements equal to the number of rows or columns in the destination tile register. For example, in some implementations the input vectors are 512-bits in length and are divided into 16 elements of 32-bits. One input vector is used as a row input, the other as a column input. Each matrix engine includes a plurality of arithmetic elements arranged in rows and columns to receive the respective vector inputs. The outer product operation executes a dot product at every arithmetic element, using the intersecting row and column elements as input to each corresponding arithmetic element.

Each matrix engine 120 includes a plurality of BSRs (e.g., BSR 115) that are collectively configured to a framework that supports block scale formats, such as the OCP MX data format, in outer product operations. These block scale formats associate a shared scale term with a block of data elements. The matrix engines 120 are, as noted above, arranged to compute results of N rows x M columns, wherein each row input is be associated with one input matrix and each column input with a second input matrix. Each BSR stores a separate shared scale term associated with a corresponding row and column. In operation, during a matrix operation, each arithmetic element multiplies and accumulates corresponding input data, and further combines the corresponding shared scale terms and adjusts, based on the combined scale terms, the magnitude of the partial result prior to accumulation.

To illustrate, in some implementations the BSR 115 is a physical register file (PRF) that contains a number of scale elements. Each arithmetic element of the matrix engine 120 is configured to apply the corresponding scale elements to product terms prior to accumulation during the computation of the outer product operations. The BSR 115, in implementations, is organized as two segments of, for example, 512-bits, each segment further sub-divided into, for example, four 128-bit sections. Each section then includes, for example, 16 8-bit scale elements; operations that use the scale register as input interpret the 8-bit scale elements as an, for example, an E8M0 power-of-two scale, as defined in the OCP MX standard.

In some implementations, the matrix engines 120 are configured to execute a number of outer product operations that accept, for example, OCP MX data formats as input, wherein a power-of-two scale is associated with a block of element data. The matrix engines 120 are configured to apply this block scale as part of outer product operations. For example in some implementations, the matrix engine 120-1 is configured to read two groups of scales from the corresponding BSRs. At each intersection of the row and column elements, the corresponding sub-elements are multiplied and summed by the corresponding arithmetic element. In addition, the arithmetic element combines the intersecting scale values, as provided by the BSR, to form a power-of-two scale that is applied to the sum prior to accumulation with the corresponding destination tile element.

In some implementations, to reduce bottlenecks, wire loads, power consumption, and latency, each of the matrix engines 120 includes a plurality of BSRs, with each BSR assigned to an NxN group (e.g. arithmetic element group 117) of arithmetic elements. Each BSR stores the scale factors for the corresponding group of arithmetic elements. This reduces the system resources required to provide the scale factors to each group of arithmetic elements, while conserving the overall circuit area consumed by the BSR.

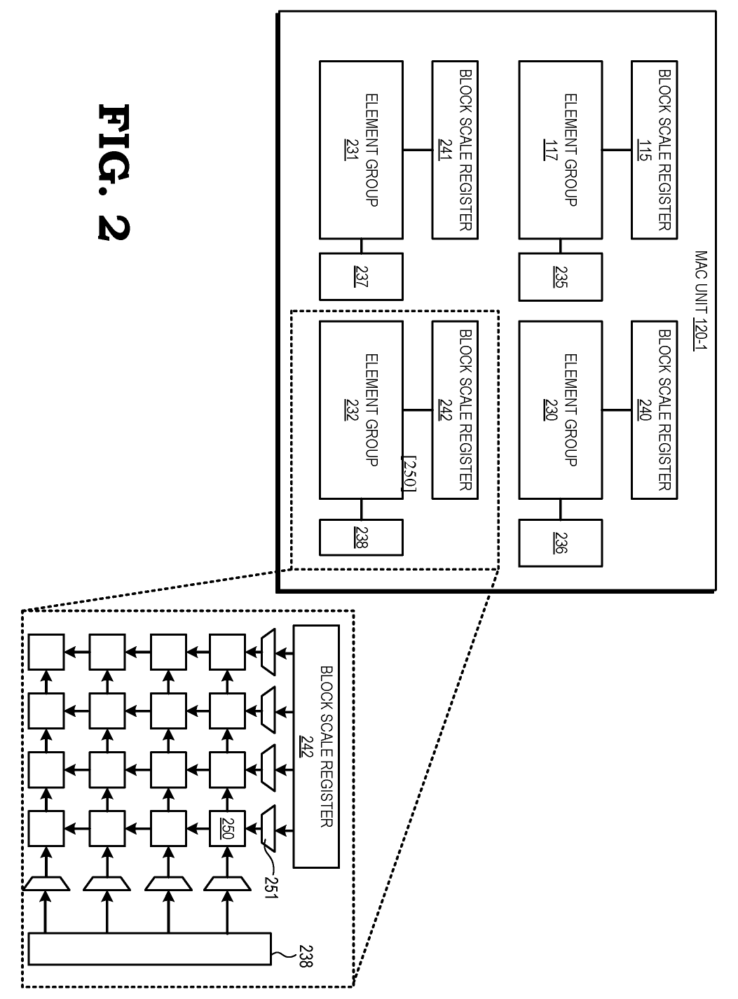

An example configuration of the matrix engine 120 is illustrated at FIG. 2 in accordance with some implementations. In the depicted example, the matrix engine 120 includes four groups of arithmetic elements, designated element groups 117, 230, 231, and 232. Each of the element groups 117, 230, 231, and 232 includes a 4x4 group of arithmetic elements. That is, each element group includes 16 arithmetic elements arranged in 4 rows (with 4 elements each) and 4 columns (with 4 elements each). Each arithmetic element (e.g., arithmetic element 250) is configured to receive corresponding matrix element inputs from corresponding tile registers (not shown for clarity), with one input being received along the row of the element and the other input being received along the column. Each arithmetic element also receives a scale factor along the row (referred to for purposes of description as the row scale factor) and receives a scale factor along the column (referred to as the column scale factor). Each arithmetic element includes circuitry configured to multiply and sum the input values, and to combine the scale values and apply the combined scale value (as, for example, a power of two) to the sum prior to accumulation with the corresponding destination tile element.

To provide the row and column scale factors to each of the element groups, the matrix engine 120 includes a corresponding pair of BSRs for each element group. Thus, in the illustrated implementation, the matrix engine 120 includes the block scale register 115 to provide column scale factors to the element group 117 and the BSR 235 to provide row scale factors to the element group 117. The matrix engine 120 also includes BSR 240 to provide column scale factors to the element group 230 and the BSR 236 to provide row scale factors to the element group 230. The matrix engine 120 further includes BSR 241 to provide column scale factors to the element group 231 and the BSR 237 to provide row scale factors to the element group 231. In addition, the matrix engine 120 includes BSR 242 to provide column scale factors to the element group 232 and the BSR 238 to provide row scale factors to the element group 232.

Each of the element groups 117, 230, 231, and 232 includes a set of multiplexors (e.g., multiplexor 251), wherein each multiplexor is assigned to a different element (not all multiplexors are shown at FIG. 2 for clarity. Each multiplexor is configured to provide a corresponding portion of the data stored at the corresponding BSR to the associated element. Thus, for example, in some implementations each BSR is a 128-bit register, with a different 32-bit portion of the register assigned to each row or column, respectively. Each multiplexor is configured to select, for its connected arithmetic element, a different 8 bit value from the corresponding 32-bit portion, thereby applying the appropriate scale factor to each of the arithmetic elements.

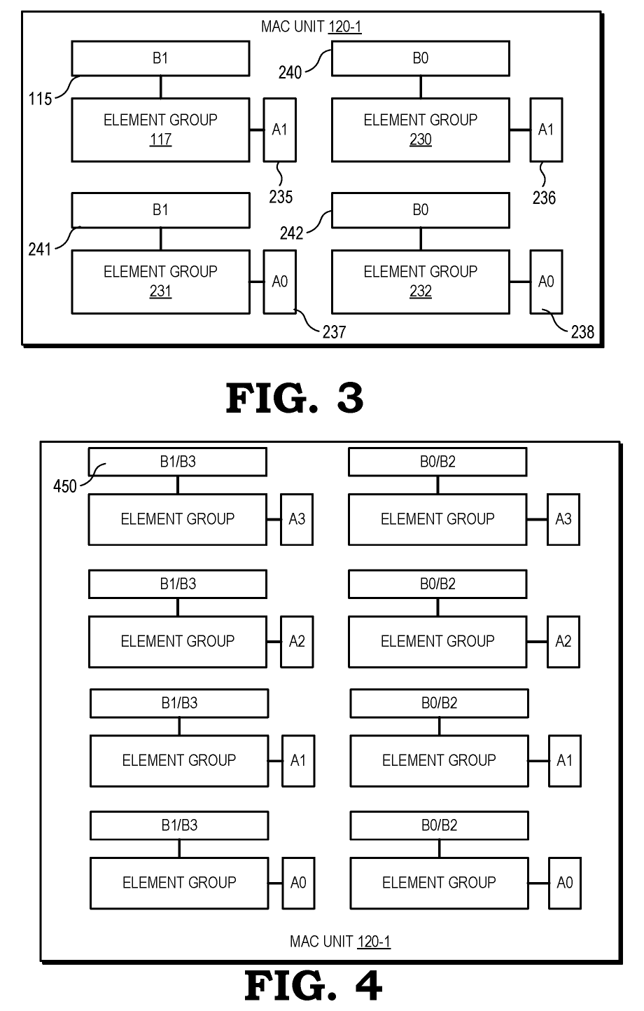

In some implementations, to calculate a dot product or other matrix value, the matrix engine is configured to apply the scale values in different configurations to different elements of the input matrices. An example is illustrated at FIG. 3 in accordance with some implementations. In the depicted example, the overall row scale factor (that is, the scale factor applied as a row input) is designated as a vector A, with sub-vectors A0 and A1 (representing a lower and upper portion of the vector A, respectively). Further the overall column scale factor is designated a vector B, with sub vectors B0 and B1. To apply the scale factors A and B via the different element groups, the scale factor sub-vectors are stored (e.g., via an arithmetic operation provided by the dispatcher 118) in different combinations at the BSRs of the matrix engine 120. Thus, in response to a dot product operation, the matrix engine 120 loads the B0 sub-vector to the BSRs 240 and 242, and the B1 sub-vector to the BSRs 115 and 241. In addition, the matrix engine 120 loads the A0 sub-vector to the BSRs 237 and 238, and loads the A1 sub-vector to the BSRs235 and 236, thereby ensuring proper application of the scale factors for calculation of the dot product.

In some implementations, the matrix engine is arranged to have a different number of element groups in each column than in each row (or vice-versa). In such configurations, at least one of the BSRs includes two physical registers to store different sub-vectors of a corresponding scale factor, and the sub-vectors are multiplexed, in the time domain, to apply the different sub-vectors on alternating clock cycles. An example is illustrated at FIG. 4 in accordance with some implementations. In the illustrated example, the matrix engine 120 includes two columns and four rows of element groups, with each element group including a four-by-four array of arithmetic elements, similar to FIG. 2. The matrix engine 120 further includes a different row BSR for each element group, configured to provide scale factors to the rows of the arithmetic elements, and a different column BSR for each element group, configured to provide scale factors to the columns of the element groups.

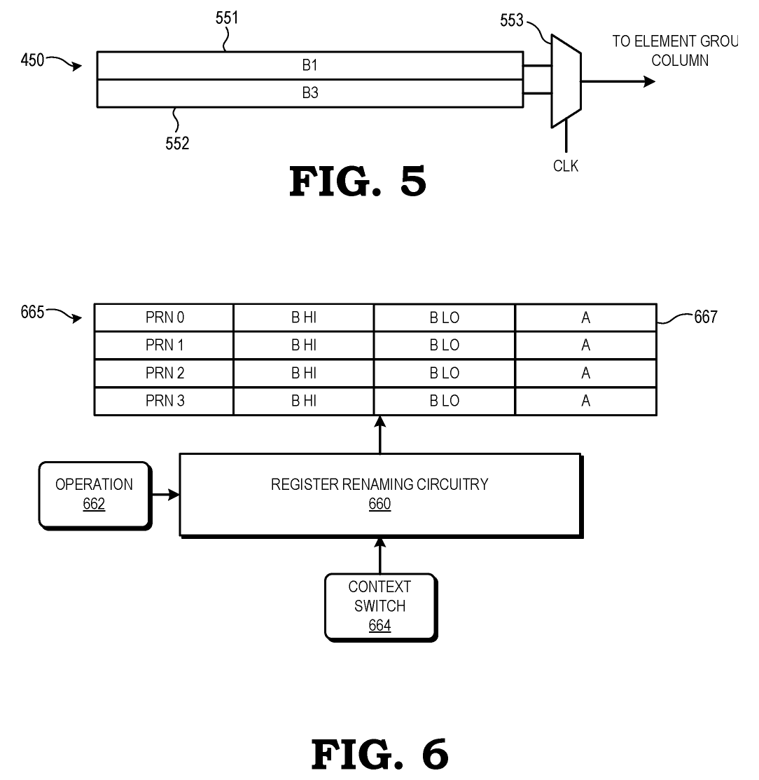

Because of the asymmetry between the rows and columns (that is, because there are more rows than columns) the row BSRs are each configured to provide one quarter portion of the row scale factor vector A, while the column BSRs are configured to provide different quarter portions of the column scale factor vector B on alternate clock cycles. This can be better understood with reference to FIG. 5, which illustrates an example of a BSR 450 in accordance with some implementations. In the illustrated example, the BSR 450 includes physical registers 551 and 552 and a multiplexor 553. The physical registers 551 and 552 are configured to store different sub-vectors of the column scale factor vector B. In the depicted example the physical register 551 stores the sub-vector B1 and the physical register 552 stores the sub-vector B3.

The multiplexor 553 includes an input connected to the register 551, an input connected to the register 552, a control input to receive a clock signal, and an output connected to the columns of the corresponding element group. During execution of a dot product or other operation, the multiplexor is configured to provide, on alternating clock signals, the contents of the register 551 and the contents of the register 552, respectively. By multiplexing different physical registers in this way, the processing system 100 supports matrix engines having different arrangements of element groups, such as matrix engines having different numbers of element groups in the group rows and columns, as in the example of FIG. 4.

In some implementations, the BSRs of the matrix engine 120 are implemented as physical register files (PRFs), thereby allowing the matrix engine 120 to efficiently change the scale factors stored at the BSRs in response to a context switch (that is, in response to a change in the thread being executed) at the CPU 101, or in response to a change in instructions within a thread, thereby allowing out-of-order execution. An example is illustrated at FIG. 6 in accordance with some implementations. In the illustrated example, a BSR (e.g., BSR 115) is implemented as PRF 665. The PRF 665 includes four physical register entries (e.g. entry 667), with each entry including a physical register number (PRN), a register that stores a column scale factor vector (designated B HI) to be provided when a clock signal is in an asserted (or “high”) state, a register that stores a column scale factor vector (designated B LO) to be provided when the clock signal is in a negated (or “low”) state, and a register to store a row scale vector. It will be appreciated that the values for the different scale vectors for the different entries are, at least in some cases, different values.

FIG. 6 further illustrates register renaming circuitry 660, generally configured to manage register renaming for the matrix engine 120. In particular, in the register renaming circuitry 660 is configured to assign each of the entries of the PRF 665 to a different thread or instruction scheduled for execution at the CPU 101. For purposes of description, it is assumed that the example of FIG. 6 is based on a context switch. The register renaming circuitry 660 is configured to receive context switch indications, such as context switch 664. Each context switch indicates the thread being executed at the CPU 101 (that is, the thread to which the CPU 101 is switching). In response to receiving a context switch, the register renaming circuitry 660 attaches the executing thread’s assigned PRN to the scale factor register name for matrix operations. Thus, in response to receiving an operation (e.g., operation 662) designating a BSR, the matrix engine 120 executes the operation using the physical registers indicated by the assigned PRN. This allows the matrix engine 120 to respond to context switches efficiently, without repeated transfers of scale factor data between registers and memory. In some implementations, each thread is associated with multiple BSRs, thereby supporting register renaming within a thread, such as for executing thread instructions out-of-order (that is, in a different order than a program order). Thus, in some implementations, register renaming is implemented both for context switches between threads, and for supporting multiple architectural registers per thread.

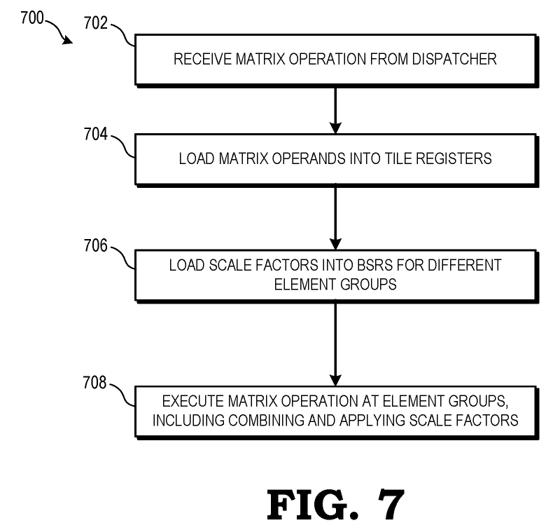

FIG. 7 illustrates a flow diagram of a method 700 of executing a matrix operation at a processing system in accordance with some implementations. The method 700 is described with respect to an example implementation at the processing system 100 of FIG. 1, but it will be appreciated that in some implementations the method 700 is implemented at a processing system having a different configuration. At block 702, a matrix engine 120 receives a matrix operation from the dispatcher 118. For example, in some implementations the CPU 101 executes an application, such as an artificial intelligence or machine learning application, that includes instructions associated with matrix operations, such as dot product operations, matrix multiplication operations, and the like. These instructions are decoded into sets of operations, including matrix operations that request the matrix engine 120 to perform one or more matrix arithmetic functions. In some cases, the matrix operations is a collection of operations, including operations to load matrix operand data into one or more tile registers, operations to load scale factors to one or more BSRs, and operations to store any result of the matrix operation to a register, to a memory, and the like. In some implementations, the matrix engine 120 is configured to set a block scale register to a specified value (e.g., zero, 0x7F) by mapping the BSR to an invalid physical register number.

At block 704, in response to the received matrix operation, the matrix engine 120 (or other execution unit, such as a load/store unit) loads matrix operand data to one or more tile registers of the CPU 101. For example, if the operation represents a request to multiply two matrices C and D, at block 704 the matrix engine 120 loads the matrices C and D to one or more tile registers for access by the arithmetic elements of the matrix engine 120.

At block 706, in response to the received matrix operation, the matrix engine 120 loads scale factors to the BSRs of the matrix engine 120. For example, in some implementations, the operation indicates scale factors, designated scale factor A and scale factor B, to be applied to the matrices C and D, respectively, during the matrix multiplication or other matrix operation. The matrix engine 120 loads different portions of the scale factors A and B to the different BSRs for the different arithmetic element groups, so that the scale factors are applied to the proper elements of the matrices C and D during the matrix multiplication.

At block 708, in response to the received matrix operation, the matrix engine 120 performs the matrix operation by executing, at each arithmetic element, a corresponding arithmetic operation, such as an outer product operation. To perform the arithmetic operation, each arithmetic element employs a corresponding element, or set of elements, of the matrices C and D. In addition, each arithmetic element scales the elements or set of elements, of the matrices C and D using the scale factor provided by the corresponding BSR.

In some implementations, the matrix engine 120 executes the matrix operation by loading matrices into one or more tile registers and loading scale factors into the different BSR. The matrix engine 120 then sequentially moves rows and columns from two larger matrices (as stored in the one or more tile matrices) into the arithmetic elements for the matrix operation and scales the rows and columns by scale factors stored at the corresponding the BSR. The matrix engine 120 then accumulates the result into the tile register. After all the rows and columns of the larger matrices have been processed, the matrix engine 120 unloads the result from the tile register (by, e.g., storing the result at another register or in memory). The matrix engine 120 repeats this process until the entire resultant matrix product is calculated and stored.

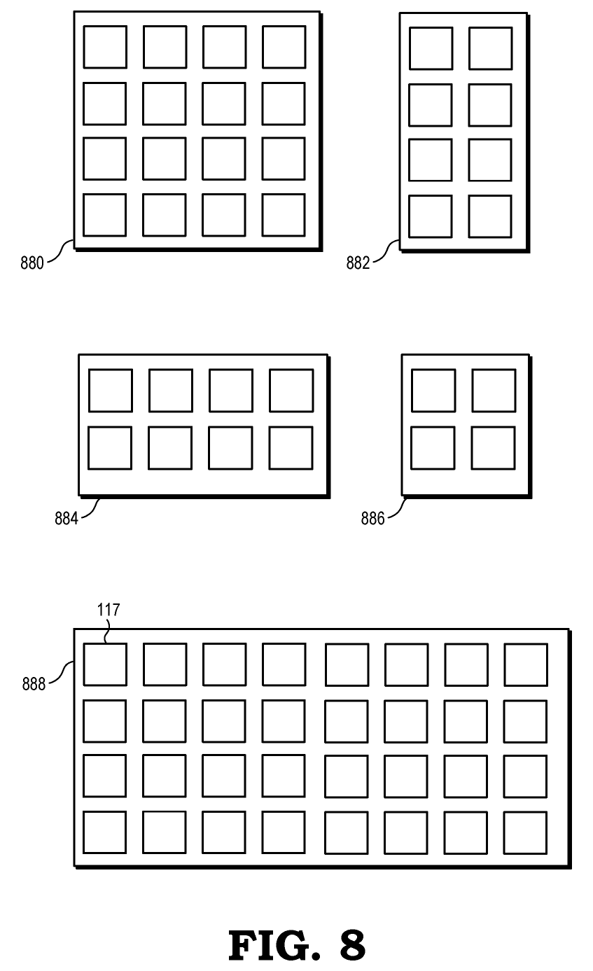

The BSRs described herein support scalable matrix engines that, in different implementations, are formed or manufactured to have different configurations. Example configurations are illustrated at FIG. 8 in accordance with some implementations. In particular, FIG. 8 illustrates matrix engine configurations 880, 882, 884, 886, and 888 (collectively referred to as configurations 882-888), with each of the configurations 880-888 including a different number and arrangement of arithmetic element groups (e.g., arithmetic element group 117).

Thus, for configuration 880, the element groups are arranged in four rows and four columns, with each element group including BSRs (not shown) to provide scale factors to the different elements as described herein. For configuration 882, the element groups are arranged in two columns and four rows. For configuration 884, the element groups are arranged in four columns and two rows. For configuration 886, the element groups are arranged in two columns and two rows. For configuration 888, the element groups are arranged in eight columns and four rows. It will be appreciated that in other implementations, other configurations are used.

Referring to configuration 882, in some implementations the configuration includes a 2 x 4 array of groups of 4 x 4 elements, resulting in an overall matrix size of 8 x 16 elements, in which the right two columns from the full configuration are positioned above the left two columns, resulting in a more compact vertical layout relative to configuration 880. Thus, the configuration includes only 8 groups of 4 x 4 elements, with each group of elements performing the functionality of 2 groups of elements depicted in configuration 880 (i.e., the left column of the horizontally folded matrix engine configuration 882 performs the operations of columns 1 and 3 of the full-scale matrix engine configuration 800 and the right column of the horizontally folded matrix engine 882 performs the operations of columns 0 and 2 of the full-scale matrix engine 800).

In some implementations, the data buses (not shown) of configuration 882 are multiplexed on the columns such that it takes two clocks instead of one to process the full 16 x 16 matrix. On the first clock, columns 0 and 1 are multiplied by rows 0 to 3. On the second clock, columns 2 and 3 are multiplied by rows 0 to 3. The horizontally folded matrix engine configuration 882 can perform a pipelined outer dot product operation in two clock cycles with a latency of, e.g., 11 clocks.

In some implementations, despite the decrease by 50% in math circuitry, all 16 x 16 products are accumulated individually. In some implementations, products are accumulated into an entry in the physical register file (PRF) called a physical register number (PRN). The full-scale matrix engine configuration 800 includes a single storage location (referred to herein as a sub PRN) for each PRN. The sub PRN holds the accumulated products for a given element. In the single-folded, reduced-size configuration 802, each element stores two accumulated products. Each of these accumulated products is stored in a sub PRN within a single PRN in some implementations.

On the first clock, the accumulated product is read from the first sub PRN, the results of the first multiply operation (C0 and C1 * R0 through R3) are added to it, and the result is written back to the first sub PRN. On the second clock, the accumulated product is read from the second sub PRN, the results of the second multiply operation (C2 and C3 * R0 through R3) are added to it, and the result is written back to the second sub PRN. Thus, for each fold, the number of PRNs remains constant, the number of sub PRNs doubles, and the depth of the PRF doubles, but the total number of PRFs in the design is halved (as with the number of elements).

In some implementations, the scalable matrix engine is configured as a vertically folded matrix engine configuration 884. The vertically folded matrix engine configuration 884 includes a 4 x 2 array of groups of arithmetic elements, in which the full-scale matrix engine configuration 880 is folded along the horizontal axis, maintaining the full width but reducing the height to result in an overall matrix size of 16 x 8 elements. Like the horizontally folded matrix engine configuration 882, this configuration processes operations over multiple cycles.

In some implementations, the scalable matrix engine is configured as a twice folded matrix engine configuration 886. The twice folded matrix engine configuration 886 is a 2 x 2 arrangement of arithmetic elements that combines both horizontal and vertical folding. In the twice folded matrix engine configuration 886, both the row and column buses are multiplexed into the elements, each outer dot product takes four clocks, and each PRN has four sub PRNs. The total number of elements is one-fourth the number of elements in the full-scale matrix engine configuration 880.

In other implementations, the scalable matrix engine is configured as a double matrix engine 888 or as a 256-bit mini matrix engine (not shown). The double matrix engine 888 includes two full-scale matrix engine configurations (similar to configuration 880) arranged side by side, allowing for processing of increased bit width without adding clock cycles.

In some implementations, the matrix unit is configured as a mini configuration matrix engine. In the example of the mini configuration matrix engine, the widths of the buses are halved from 512 bits to 256 bits and the 512-bit data from the CPU is presented on alternating clocks to maintain compatibility with the 512-bit ISA. The muxing / TDM multiplexing that the scalable matrix engine otherwise performs in smaller configurations with a 512-bit bus is performed by the CPU instead of being performed by the mini configuration matrix engine. The mini configuration matrix engine includes a reduced 2 x 2 arrangement of arithmetic element groups, thereby maintaining architectural compatibility with larger implementations.

In some implementations, each of the above-described configurations maintains the same internal structure within individual arithmetic element groups, allowing for consistent operation across different physical implementations. In some implementations, the different configurations of the matrix unit allow for trade-offs between performance, power consumption, and die area while preserving compatibility with existing software. The ability to scale the matrix engine enables a single instruction set architecture and code base to run unmodified across various hardware implementations, thus simplifying software development and maintenance across a range of products with different performance requirements.

In some implementations, the PRF depth is function of the number of architectural registers, the number of threads, our internal token loop requirements, our internal register renaming / out-of-order execution requirements, and the number of sub PRNs required. The number of sub PRNs required doubles for each folding from the base configuration. The chart below illustrates some examples. For the folded configurations, due to the need for fewer PRNs, there is some area efficiency in the PRF versus the full configuration.

In some implementations, the some arithmetic hardware (e.g., one or more multipliers) is located outside the element groups and shared between multiple arithmetic elements (e.g., shared between four arithmetic elements). For example, in some implementations circuitry used to perform expensive but infrequently used math operations is be shared among arithmetic elements. An example is illustrated at FIG. 4 in accordance with some implementations. In particular, FIG. 4 is a block diagram showing a group of 4 x 4 arithmetic elements (e.g., elements 990, 992) in which multiplier hardware (e.g., multiplier 994) is shared between subgroups of 2 x 2 elements in accordance with some embodiments.

In the illustrated example a single multiplier is shared among four elements. In this case, on each clock, one of the four elements obtains access to the multiplier. The element that has access reads the accumulated value stored in the requested PRN and feeds it to the shared multiplier. Once the multiply-accumulate is complete, the shared multiplier feeds the new accumulated value back to the element for storage in its PRF until the next time it is needed. This process repeats on a round-robin time domain multiplexed basis until all four elements have accumulated their products. In another configuration, the multiplier circuits remain inside the elements but the PRFs are moved outside the elements and arranged as one or more wider PRFs.

By sharing resources such as multipliers and PRFs among multiple elements, the matrix engine 980 improves resource utilization while maintaining processing capabilities. In addition, the illustrated implementation supports more efficient use of die area and potentially reduce power consumption in some implementations.

In some cases, the scalable matrix engine implements an early exit mechanism for improved efficiency. This mechanism allows the matrix unit to detect when all input values for a particular pipeline pass are zero. When such a condition is detected, the scalable matrix engine skips unnecessary computations for that pass, thereby reducing power consumption and improving overall performance.

The early exit mechanism operates by examining the input data at the beginning of each pipeline pass. If all input values are determined to be zero, the scalable matrix engine bypasses the multiply-accumulate operations for that pass and proceeds to the next set of inputs. This optimization is beneficial for sparse matrix operations where many elements are zero.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processor, comprising:
a matrix arithmetic unit configured to perform matrix operations, the matrix arithmetic unit including:
a plurality of arithmetic element groups including a first element group and a second element group, each of the plurality of arithmetic element groups including a plurality of matrix arithmetic elements; and
a first block scale register configured to provide a first scale factor to the first element group and a second block scale register configured to provide a second scale factor to the second element group.

2. The processor of claim 1, wherein the matrix arithmetic unit further comprises:
a third block scale register configured to provide a third scale factor to the first element group.

3. The processor of claim 2, wherein the matrix arithmetic unit further comprises:
a fourth block scale register configured to provide the third scale factor to the second element group.

4. The processor of claim 2, wherein:
the first block scale register is configured to provide data to each column of the first element group; and
the third block scale register is configured to provide data to each row of the first element group.

5. The processor of claim 2, wherein the matrix arithmetic unit further comprises:
a fourth block scale register configured to provide a fourth scale factor to the first element group.

6. The processor of claim 5, wherein the matrix arithmetic unit is configured to multiplex data provided by the first block scale register and the fourth block scale register.

7. The processor of claim 2, wherein the first block scale register comprises a physical register file including a plurality of physical registers.

8. The processor of claim 7, wherein the physical register file comprises a first register and a second register configured to provide scale factors to the first element group via a multiplexor.

9. The processor of claim 1, wherein the matrix arithmetic unit is configured to set the first block scale register to a specified value by mapping the first block scale register to an invalid physical register number.

10. A processing system, comprising:
a memory configured to store at least one program that, when executed, generates matrix operations; and
a processor, comprising:
a matrix arithmetic unit configured to perform matrix operations, the matrix arithmetic unit including:
a plurality of arithmetic element groups including a first element group and a second element group, each of the plurality of arithmetic element groups including a plurality of matrix arithmetic elements; and
a first block scale register configured to provide a first scale factor to the first element group and a second block scale register configured to provide a second scale factor to the second element group.

11. The processing system of claim 10, wherein the matrix arithmetic unit further comprises:
a third block scale register configured to provide a third scale factor to the first element group.

12. The processing system of claim 11, wherein the matrix arithmetic unit further comprises:
a fourth block scale register configured to provide the third scale factor to the second element group.

13. The processing system of claim 11, wherein:
the first block scale register is configured to provide data to each column of the first element group; and
the third block scale register is configured to provide data to each row of the first element group.

14. The processing system of claim 11, wherein the matrix arithmetic unit further comprises:
a fourth block scale register configured to provide a fourth scale factor to the first element group.

15. The processing system of claim 14, wherein the matrix arithmetic unit is configured to multiplex data provided by the first block scale register and the fourth block scale register.

16. The processing system of claim 11, wherein the first block scale register comprises a physical register file including a plurality of physical registers.

17. The processing system of claim 16, wherein the physical register file comprises a first register and a second register configured to provide scale factors to the first element group via a multiplexor.

18. The processing system of claim 10, wherein the matrix arithmetic unit is configured to set the first block scale register to a zero value by mapping the first block scale register to an invalid physical register number.

19. A method, comprising:
in response to receiving a matrix operation at a matrix arithmetic unit:
executing the matrix operation at a plurality of arithmetic element groups of a matrix engine, the plurality of arithmetic element groups including a first element group and a second element group, each of the plurality of arithmetic element groups including a plurality of matrix arithmetic elements; and
accessing a first block scale register to provide a first scale factor to the first element group and a second block scale register to provide a second scale factor to the second element group.

20. The method of claim 19, further comprising:
accessing a third block scale register to provide a third scale factor to the first element group.
